(19) United States
(12) Patent Application Publication
(10) Pub. No.: US 2014/0210701 A1
(43) Pub. Date: Jul. 31, 2014

(54) ELECTROPHORETIC DISPLAY

(71) Applicant: SiPix Technology, Inc., Taoyuan (TW)

(72) Inventors: Yan-Liang Wu, Kaohsiung City (TW); Chi-Mao Hung, Hsinchu City (TW); Wei-Min Sun, Taipei City (TW); Pei-Lin Tien, Taichung City (TW); Chih-Yuan Hsu, Taipei City (TW); Hsiao-Lung Cheng, Taoyuan County (TW)

(73) Assignee: SiPix Technology, Inc., Taoyuan (TW)

(21) Appl. No.: 14/161,697

(22) Filed: Jan. 23, 2014

(30) Foreign Application Priority Data
Jan. 25, 2013 (TW) 102102927

(51) Int. Cl. G09G 3/34

(52) U.S. Cl. CPC G09G 3/344
USPC 345/107

(57) ABSTRACT

An electrophoretic display includes an electrophoretic panel and a plurality of first scan lines. The electrophoretic panel has a first axis direction. The plurality of first scan lines are installed on the first axis direction. A coupled line parallel to the first axis direction is installed between each two adjacent first scan lines, and the coupled line is coupled to ground.

### BACKGROUND OF THE INVENTION

1. Field of the Invention

The present invention relates to an electrophoretic display, and particularly to an electrophoretic display that can utilize a coupled line installed between each two adjacent first scan lines, utilize a coupled line installed between each two adjacent second scan lines, or simultaneously utilize a coupled line installed between each two adjacent first scan lines and a coupled line installed between each two adjacent second scan lines to reduce passive matrix coupling effect.

2. Description of the Prior Art

Please refer to FIG. 1 and FIG. 2. FIG. 1 is a diagram illustrating a pixel P1, first scan lines C1, C2 and second scan lines R1, R2 of an electrophoretic panel according to the prior art, and FIG. 2 is a diagram illustrating an equivalent circuit among storage capacitors CP1, CP2, CP4, CP5 corresponding to pixels P1, P2, P4, P5, and a parasitic capacitor CX between the first scan line C1 and the first scan line C2 when the pixel P1 is driven. As shown in FIG. 1, when the pixel P1 is driven, a driving voltage (e.g. 15V) is applied to the first scan line C1, the second scan line R1 is coupled to ground GND (0V) and other first scan lines and other second scan lines of the electrophoretic panel are floating, where the first scan line C1 coupled to the pixel P1 is located on a first axis direction of the electrophoretic panel, the second scan line R1 coupled to the pixel P1 is located on a second axis direction of the electrophoretic panel, and the first axis direction is perpendicular to the second axis direction. Therefore, the pixel P1 can display a first color (e.g. black color) according to a voltage drop (15V-0V) between the driving voltage and the ground GND stored in the storage capacitor CP1, and each pixel of other pixels of the electrophoretic panel can display a previous displayed color.

As shown in FIG. 2, when the driving voltage is applied to the first scan line C1, the driving voltage can be coupled to the storage capacitor CP2 corresponding to the pixel P2 through the storage capacitors CP4, CP5 and the parasitic capacitor CX, resulting in the pixel P2 displaying a color not wanted by a user (e.g. black color, white color, or neither black color nor white color). Therefore, the prior art is not a good driving method for the electrophoretic panel.

### SUMMARY OF THE INVENTION

An embodiment provides an electrophoretic display capable of reducing passive matrix coupling effect. The electrophoretic display includes an electrophoretic panel and a plurality of first scan lines. The electrophoretic panel has a first axis direction. The plurality of first scan lines are installed on the first axis direction. A coupled line parallel to the first axis direction is installed between each two adjacent first scan lines, and the coupled line is coupled to ground.

Another embodiment provides an electrophoretic display capable of reducing passive matrix coupling effect. The electrophoretic display includes an electrophoretic panel, a plurality of first scan lines, and a plurality of second scan lines. The electrophoretic panel has a first axis direction and a second axis direction. The plurality of first scan lines are installed on the first axis direction. The plurality of second scan lines are installed on the second axis direction, wherein the first axis direction is perpendicular to the second axis direction. But, the present invention is not limited to the first axis direction being perpendicular to the second axis direction. A first coupled line parallel to the first axis direction is installed between each two adjacent first scan lines, a second coupled line parallel to the second axis direction is installed between each two adjacent second scan lines, and the first coupled line and the second coupled line are coupled to ground.

The present invention provides an electrophoretic display capable of reducing passive matrix coupling effect. The electrophoretic display utilizes a coupled line parallel to a first axis direction of an electrophoretic panel installed between each two adjacent first scan lines, utilizes a coupled line parallel to a second axis direction of the electrophoretic panel installed between each two adjacent second scan lines, or simultaneously utilizes a coupled line parallel to the first axis direction of the electrophoretic panel installed between each two adjacent first scan lines and a coupled line parallel to the second axis direction of the electrophoretic panel installed between each two adjacent second scan lines to reduce a coupling voltage coupled to a pixel of the electrophoretic panel. Thus, compared to the prior art, the present invention can ensure each pixel of a passive matrix panel to display a color wanted by a user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a pixel, first scan lines, and second scan lines of an electrophoretic panel according to the prior art.

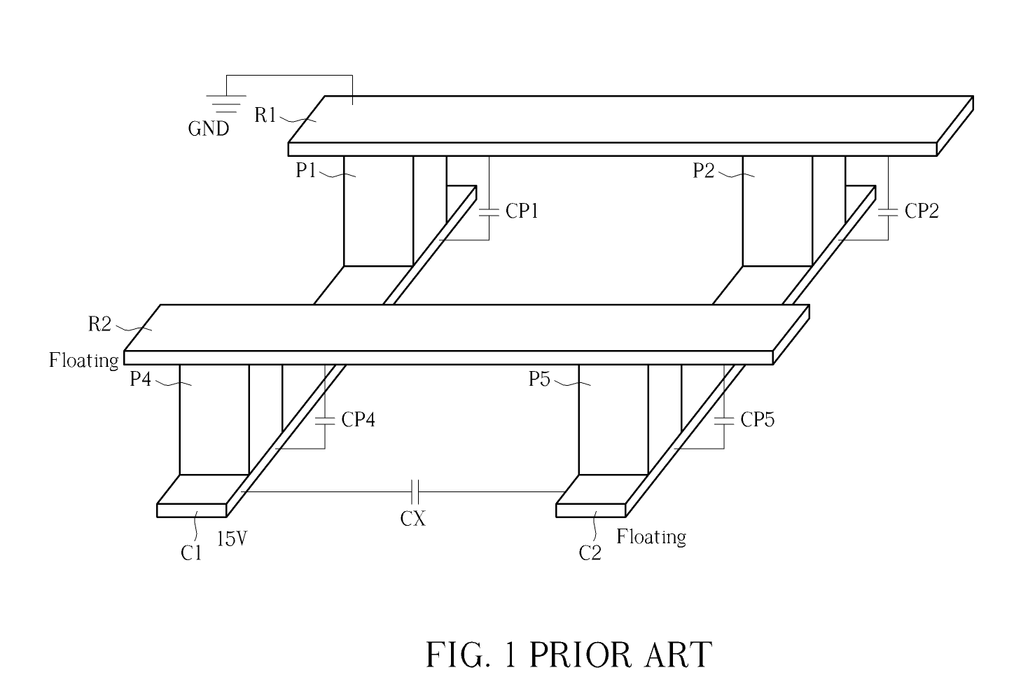

FIG. 2 is a diagram illustrating an equivalent circuit among storage capacitors and a parasitic capacitor between the first scan line and the first scan line when the pixel is driven.

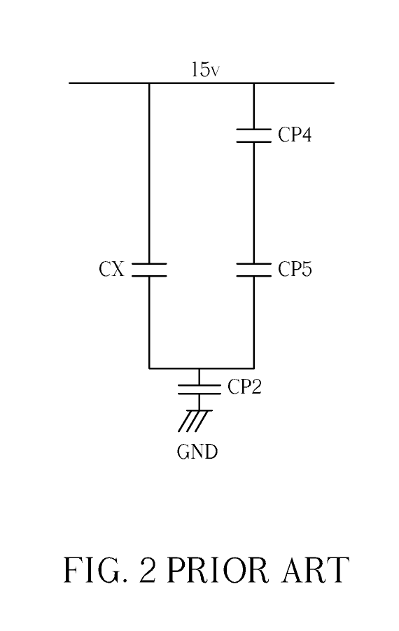

FIG. 3 is a diagram illustrating an electrophoretic display capable of reducing passive matrix coupling effect according to an embodiment.

FIG. 4 is a diagram illustrating an equivalent circuit among the storage capacitors and parasitic capacitors between the first scan line, the first scan line, and the coupled line when the pixel is driven.

FIG. 5 is a diagram illustrating an electrophoretic display capable of reducing passive matrix coupling effect according to another embodiment.

FIG. 6 is a diagram illustrating an equivalent circuit among the storage capacitors and parasitic capacitors between the first scan line, the first scan line, and the coupled line when the pixel is driven.

FIG. 7 is a diagram illustrating an electrophoretic display capable of reducing passive matrix coupling effect according to another embodiment.

### DETAILED DESCRIPTION

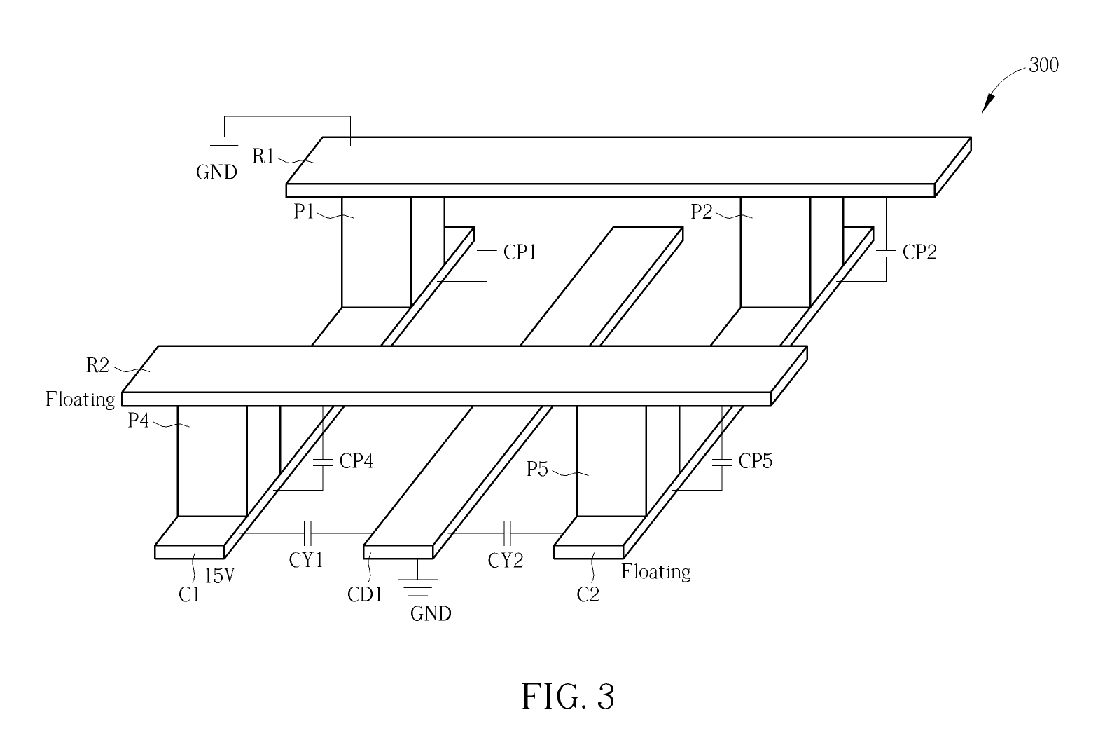

Please refer to FIG. 3. FIG. 3 is a diagram illustrating an electrophoretic display 300 capable of reducing passive matrix coupling effect according to an embodiment. The electrophoretic display 300 includes an electrophoretic panel (passive matrix panel not sown in FIG. 3), a plurality of first scan lines, and a plurality of second scan lines. The electrophoretic panel includes a plurality of pixels, and each pixel of the plurality of pixels corresponds to a storage capacitor. The plurality of first scan lines of the electrophoretic display 300 are installed on a vertical axis direction of the electrophoretic panel, and the plurality of second scan lines of the electrophoretic display 300 are installed on a horizontal axis direction of the electrophoretic panel, wherein a coupled line is installed between each two adjacent first scan lines and parallel to the each two adjacent first scan lines, the coupled line and the each two adjacent first scan lines are located on the same plane, and the coupled line is coupled to ground GND. In addition, FIG. 3 only shows first scan lines C1, C2, second scan lines R1, R2, pixels P1, P2, P4, P5, storage capacitors CP1, CP2, CP4, CP5 corresponding to the pixels P1, P2, P4, P5, respectively, and a coupled line CD1 between the first scan line C1 and the first scan line C2. The storage capacitor CP1 corresponding to the pixel P1 is coupled to the first scan line C1 and the second scan line R1, and the first scan line C1, the first scan line C2, and the coupled line CD1 are located on the same plane. When the pixel P1 is driven, a driving voltage (e.g. 15V) is applied to the first scan line C1 to drive the pixel P1, the second scan line R1 is coupled to the ground GND, other first scan lines and other second scan lines are floating. Therefore, the pixel P1 can display a first color (e.g. black color) according to a voltage drop (15V-0V) between the driving voltage and the ground GND stored in the storage capacitor CP1.

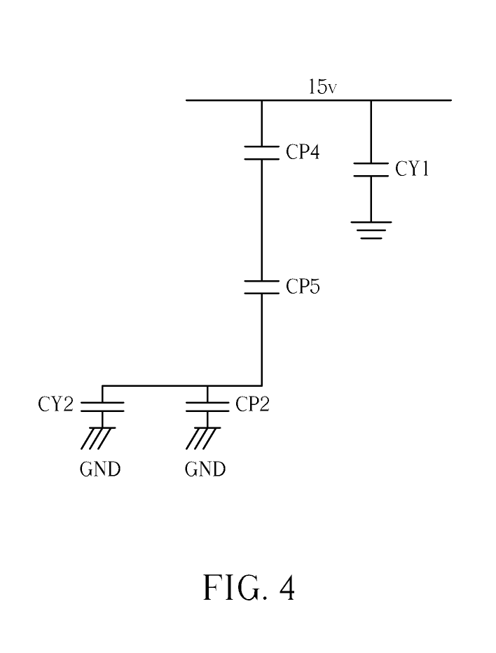

Please refer to FIG. 4. FIG. 4 is a diagram illustrating an equivalent circuit among the storage capacitors CP2, CP4, CP5 corresponding to the pixel P2, P4, P5 adjacent to the pixel P1, and parasitic capacitors CY1, CY2 between the first scan line C1, the first scan line C2, and the coupled line CD1 when the pixel P1 is driven. As shown in FIG. 4, when the pixel P1 is driven according to the driving voltage (e.g. 15V), because the parasitic capacitor CY2 is in parallel with the storage capacitor CP2 corresponding to the pixel P2, the parasitic capacitor CY2 can reduce a coupling voltage coupled to the pixel P2. In addition, FIG. 3 is only an embodiment illustrating the present invention, so the present invention is not limited to reducing the coupling voltage coupled to the pixel P2. In another embodiment of the present invention, the present invention can also reduce coupling voltages coupled to other pixels of the electrophoretic panel coupled to the second scan line R1 through other coupled lines.

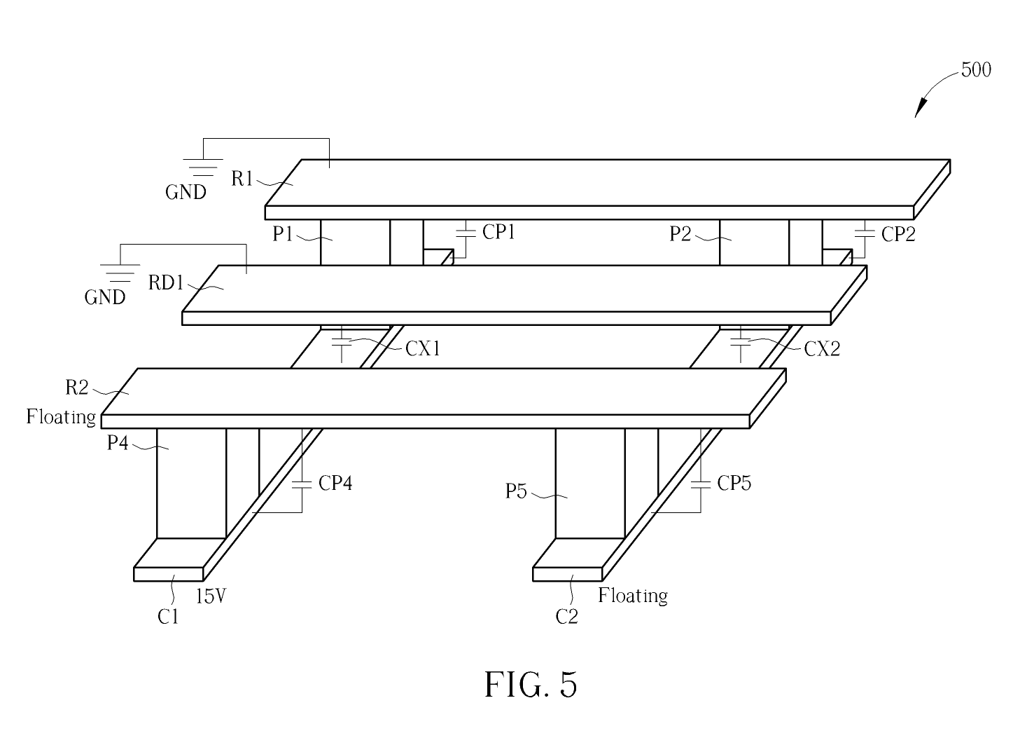

Please refer to FIG. 5. FIG. 5 is a diagram illustrating an electrophoretic display 500 capable of reducing passive matrix coupling effect according to another embodiment. A difference between the electrophoretic display 500 and the electrophoretic display 300 is that a coupled line parallel to the horizontal axis direction of the electrophoretic panel is installed between each two adjacent second scan lines. The coupled line is parallel to the each two adjacent second scan lines, the coupled line and the each two adjacent second scan lines are located on the same plane, and the coupled line is coupled to the ground GND. For example, a coupled line RD1 parallel to the horizontal axis direction of the electrophoretic panel is installed between the second scan line R1 and the second scan line R2, the second scan line R1, the second scan line R2, and the coupled line RD1 are located on the same plane. When the pixel P1 is driven, a driving voltage (e.g. 15V) is applied to the first scan line C1 to drive the pixel P1, the second scan line R1 is coupled to the ground GND, other first scan lines and other second scan lines are floating. Therefore, the pixel P1 can display a first color (e.g. black color) according to a voltage drop (15V-0V) between the driving voltage and the ground GND stored in the storage capacitor CP1.

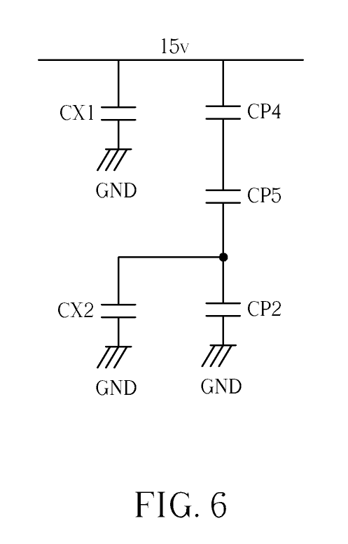

Please refer to FIG. 6. FIG. 6 is a diagram illustrating an equivalent circuit among the storage capacitors CP2, CP4, CP5 corresponding to the pixels P2, P4, P5 adjacent to the pixel P1, and parasitic capacitors CX1, CX2 between the first scan line C1, the first scan line C2, and the coupled line RD1 when the pixel P1 is driven. As shown in FIG. 6, when the pixel P1 is driven according to the driving voltage (e.g. 15V), because the parasitic capacitor CX2 is in parallel with the storage capacitor CP2 corresponding to the pixel P2, the parasitic capacitor CX2 can reduce a coupling voltage coupled to the pixel P2. Further, subsequent operational principles of the electrophoretic display 500 are the same as those of the electrophoretic display 300, so further description thereof is omitted for simplicity.

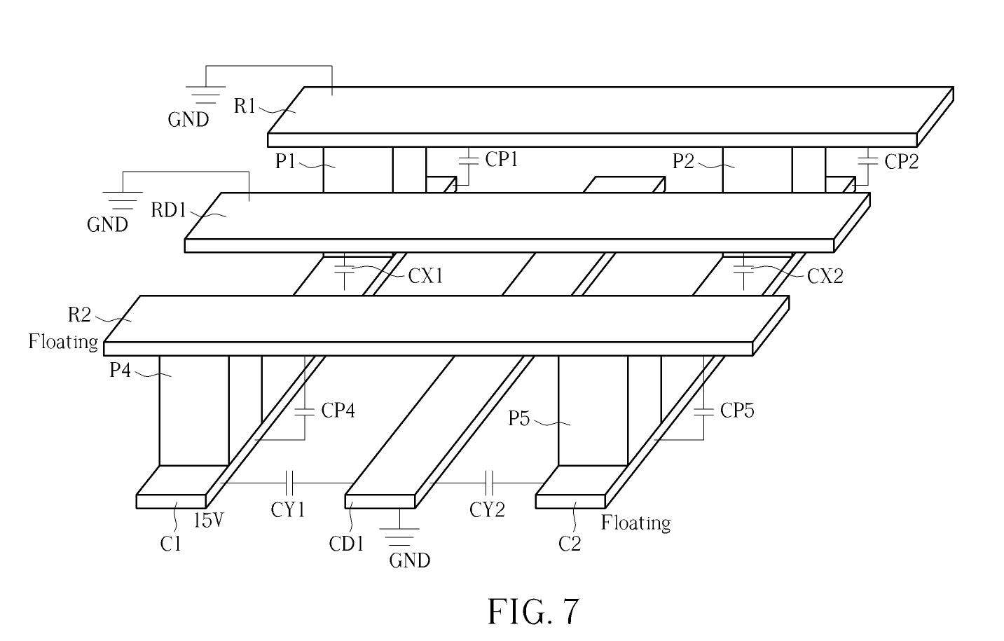

Please refer to FIG. 7. FIG. 7 is a diagram illustrating an electrophoretic display 700 capable of reducing passive matrix coupling effect according to another embodiment. As shown in FIG. 7, A difference between the electrophoretic display 700 and the electrophoretic display 300 is that a first coupled line parallel to the vertical axis direction of the electrophoretic panel is installed between each two adjacent first scan lines of the electrophoretic display 700, where the first coupled line and the each two adjacent first scan lines are located on a first plane, and the first coupled line is coupled to the ground GND; a second coupled line parallel to the horizontal axis direction of the electrophoretic panel is installed between each two adjacent second scan lines of the electrophoretic display 700, where the second coupled line and the each two adjacent second scan lines are located on a second plane, and the second coupled line is coupled to the ground GND. Further, subsequent operational principles of the electrophoretic display 700 are the same as those of the electrophoretic display 300, so further description thereof is omitted for simplicity.

To sum up, the electrophoretic display capable of reducing passive matrix coupling effect utilizes a coupled line parallel to the first axis direction (e.g. the vertical axis direction) of the electrophoretic panel installed between each two adjacent first scan lines, utilizes a coupled line parallel to the second axis direction (e.g. the horizontal axis direction) of the electrophoretic panel installed between each two adjacent second scan lines, or simultaneously utilizes a coupled line parallel to the first axis direction of the electrophoretic panel installed between each two adjacent first scan lines and a coupled line parallel to the second axis direction of the electrophoretic panel installed between each two adjacent second scan lines to reduce a coupling voltage coupled to a pixel of the electrophoretic panel. Thus, compared to the prior art, the present invention can ensure each pixel of a passive matrix panel to display a color wanted by a user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrophoretic display, comprising:
an electrophoretic panel having a first axis direction; and
a plurality of first scan lines installed on the first axis direction;
wherein a coupled line parallel to the first axis direction is installed between each two adjacent first scan lines, and the coupled line is coupled to ground.

2. The electrophoretic display of claim 1, further comprising:
a plurality of second scan lines installed on a second axis direction of the electrophoretic panel, wherein the first axis direction is perpendicular to the second axis direction.

3. The electrophoretic display of claim 2, wherein each pixel of a plurality of pixels comprised in the electrophoretic panel corresponds to a storage capacitor, the storage capacitor is used for storing a driving voltage driving the pixel, the storage capacitor is coupled to a first scan line and a second scan line, and the first scan line corresponds to the second scan line.

4. The electrophoretic display of claim 3, wherein when the pixel is driven according to the driving voltage, the driving voltage is applied to the first scan line, the second scan line is coupled to the ground, and other first scan lines and other second scan lines are floating.

5. The electrophoretic display of claim 1, wherein the two adjacent first scan lines and the coupled line are located on the same plane.

6. An electrophoretic display, comprising:
an electrophoretic panel having a first axis direction and a second axis direction;
a plurality of first scan lines installed on the first axis direction; and
a plurality of second scan lines installed on the second axis direction;
wherein a first coupled line parallel to the first axis direction is installed between each two adjacent first scan lines, a second coupled line parallel to the second axis direction is installed between each two adjacent second scan lines, and the first coupled line and the second coupled line are coupled to ground.

7. The electrophoretic display of claim 6, wherein the first axis direction is perpendicular to the second axis direction.

8. The electrophoretic display of claim 6, wherein each pixel of a plurality of pixels comprised in the electrophoretic panel corresponds to a storage capacitor, the storage capacitor is used for storing a driving voltage driving the pixel, the storage capacitor is coupled to a first scan line and a second scan line, and the first scan line corresponds to the second scan line.

9. The electrophoretic display of claim 8, wherein when the pixel is driven according to the driving voltage, the driving voltage is applied to the first scan line, the second scan line is coupled to the ground, and other first scan lines and other second scan lines are floating.

10. The electrophoretic display of claim 6, wherein the two adjacent first scan lines and the first coupled line are located on a first plane, and the two adjacent second scan lines and the second coupled line are located on a second plane.
